(19) United States
(12) Patent Application Publication
(10) Pub. No.: US 2024/0394608 A1
(43) Pub. Date: Nov. 28, 2024

(54) METHOD FOR PROVIDING POWER SUPPLY SERVICE, AND METHOD AND SYSTEM FOR RESERVING THE SAME

(71) Applicant: TOYOTA JIDOSHA KABUSHIKI KAISHA, Toyota-shi (JP)

(72) Inventors: Ryosuke KOBAYASHI, Nagakute-shi (JP); Koichi WATANABE, Tokyo (JP); Motofumi KAMIYA, Nagoya-shi (JP); Masaki NISHINO, Anjo-shi (JP); Jean-Sebastien BOIRE, Yokohama-shi (JP); Takuya NISHIOKA, Nagoya-shi (JP); Yohei NAKANISHI, Nagoya-shi (JP); Masaki MAKIHARA, Okazaki-shi (JP)

(73) Assignee: TOYOTA JIDOSHA KABUSHIKI KAISHA, Toyota-shi (JP)

(21) Appl. No.: 18/668,999

(22) Filed: May 20, 2024

(30) Foreign Application Priority Data
May 23, 2023 (KR) 2023-084753

(51) Int. Cl. G06Q 10/02; B60L 53/57; B60L 53/66

(52) U.S. Cl. CPC G06Q 10/02; B60L 53/57; B60L 53/66

(57) ABSTRACT

A method for providing a power supply service for dispatching a power supply vehicle is performed by an information processing device. The method includes determining whether there is a place where the power supply vehicle can be parked near a first space where a vehicle of a user is parked. The method further includes, when determination is made that there is the place, sending to mobile equipment of the user a first message suggesting to use the power supply service.

### CROSS-REFERENCE TO RELATED APPLICATION

This application claims priority to Japanese Patent Application No. 2023-084753 filed on May 23, 2023, incorporated herein by reference in its entirety.

### BACKGROUND

### 1. Technical Field

The present disclosure relates to methods for providing a power supply service and methods and systems for reserving the same.

### 2. Description of Related Art

For example, a technology related to providing a power supply service for dispatching a power supply vehicle in response to a request from a user is known in the art. For example, Japanese Unexamined Patent Application Publication No. 2019-086841 (JP 2019-086841 A) discloses a rescue system that selects a power supply moving object to supply power to a first moving object from a plurality of second moving objects in response to a help signal from the first moving object.

However, there is room for improvement in the technology related to providing a power supply service for dispatching a power supply vehicle.

### SUMMARY

The present disclosure improves the technology related to providing a power supply service for dispatching a power supply vehicle.

An embodiment of the present disclosure is a method for providing a power supply service for dispatching a power supply vehicle, and the method is performed by an information processing device. The method includes: determining whether there is a place where the power supply vehicle is able to be parked near a first space where a vehicle of a user is parked; and when determination is made that there is the place, sending to mobile equipment of the user a first message suggesting to use the power supply service.

Another embodiment of the present disclosure is a method for reserving a power supply service, and the method is performed by mobile equipment of a user. The method includes: sending a first request to an information processing device in response to a first operation performed on the mobile equipment; receiving a first message sent from the information processing device when there is a place where a power supply vehicle is able to be parked near a first space where a vehicle of the user is parked, the first message being a message suggesting to use the power supply service for dispatching the power supply vehicle; and sending a second request to the information processing device in response to a second operation performed on the mobile equipment, the second request being a request for a reservation to use the power supply service.

Still another embodiment of the present disclosure is a system for reserving a power supply service. The system includes: an information processing device configured to provide the power supply service for dispatching a power supply vehicle; and mobile equipment of a user. The mobile equipment is configured to send a first request to the information processing device in response to a first operation performed on the mobile equipment. The information processing device is configured to: determine in response to the first request whether there is a place where the power supply vehicle is able to be parked near a first space where a vehicle of the user is parked; and when determination is made that there is the place, send to the mobile equipment a first message suggesting to use the power supply service. The mobile equipment is configured to send a second request to the information processing device in response to a second operation performed on the mobile equipment, the second request being a request for a reservation to use the power supply service. The information processing device is configured to receive the reservation to use the power supply service in response to the second request.

According to the present disclosure, the technology related to providing a power supply service for dispatching a power supply vehicle is improved.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is a block diagram showing a schematic configuration of a system according to an embodiment of the present disclosure;

FIG. 2 is a block diagram showing a schematic configuration of an information processing device;

FIG. 3 is a block diagram showing a schematic configuration of mobile equipment;

FIG. 4 is a flowchart showing the operation of the information processing device; and

FIG. 5 is a flowchart showing the operation of the mobile equipment.

### DETAILED DESCRIPTION OF EMBODIMENTS

An embodiment of the present disclosure will be described below.

### Overview of Embodiment

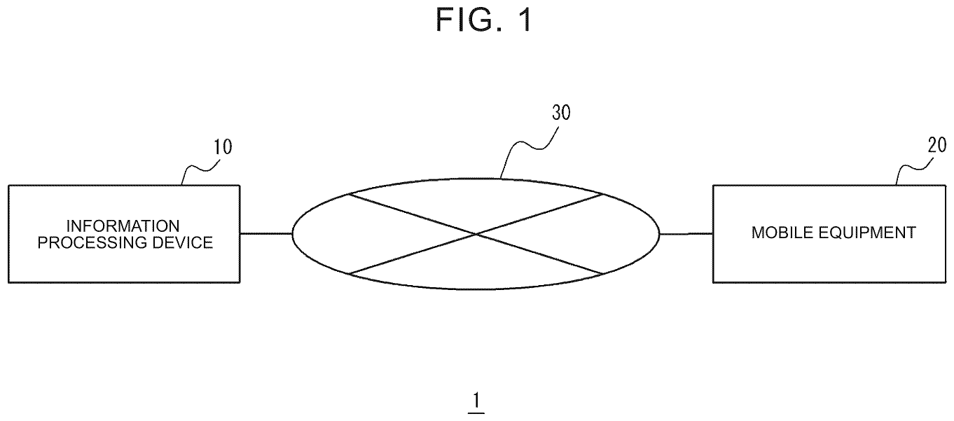

An overview of a system 1 according to an embodiment of the present disclosure will be given with reference to FIG. 1. The system 1 includes an information processing device 10 and mobile equipment 20. The information processing device 10 and the mobile equipment 20 communicate with each other via a network 30 such as the Internet.

The information processing device 10 is, for example, a computer such as a server or a personal computer (PC). In the present embodiment, the information processing device 10 is used to provide a power supply service for dispatching a power supply vehicle. Specifically, the power supply service is a service in which a power supply vehicle is dispatched to a place where a user's vehicle to which power is to be supplied is parked, and the power supply vehicle is parked near the user's vehicle to supply power to the user's vehicle by wire or wirelessly.

The mobile equipment 20 is, for example, a computer such as a smartphone, a tablet terminal, a wearable terminal, or a laptop computer. In the present embodiment, the mobile equipment 20 is carried by a user who uses a vehicle. In the present embodiment, the “vehicle” may be, but is not limited to, a motor vehicle that uses electricity as its power source, such as a battery electric vehicle (BEV), a hybrid electric vehicle (HEV), or a plug-in hybrid electric vehicle (PHEV).

In the present embodiment, the information processing device 10 can receive a reservation to use the power supply service in response to a request from the mobile equipment 20. For example, a user who has parked a vehicle in a parking lot may think of using the power supply service after the user has moved so far away from the vehicle that he or she cannot see it. In such a case, the user may make a reservation to use the power supply service with the mobile equipment 20.

However, when the user is away from the vehicle, the user cannot visually check whether there is a place near the vehicle where the power supply vehicle can be parked. Therefore, there may be no place near the vehicle where the power supply vehicle can be parked due to, for example, other vehicles being parked in the parking spaces around the user's vehicle. If, in this situation, the user makes a reservation to use the power supply service with the mobile equipment 20, the power supply vehicle that has arrived cannot be parked near the user's vehicle, and it may not be possible to provide the power supply service.

An overview of the present embodiment will be given first, and details of the present embodiment will be given later. The information processing device 10 according to the present embodiment determines whether there is a place where the power supply vehicle can be parked near a first space where the user's vehicle is parked. When the information processing device 10 determines that there is such a place, it sends to the user's mobile equipment 20 a first message suggesting to use the power supply service.

As described above, according to the present embodiment, when there is a place near the user's vehicle where the power supply vehicle can be parked, the first message suggesting to use the power supply service is sent to the user. Even when the user is away from the vehicle, checking the first message makes the user aware that there is a place near the user's vehicle where the power supply vehicle can be parked. Therefore, according to the present embodiment, the technology related to providing a power supply service for dispatching a power supply vehicle is improved in that the probability is reduced that the user may make a reservation to use the power supply service even through there is no place where the power supply vehicle can be parked.

Next, the configurations of the system 1 will be described in detail.

### Configuration of Information Processing Device

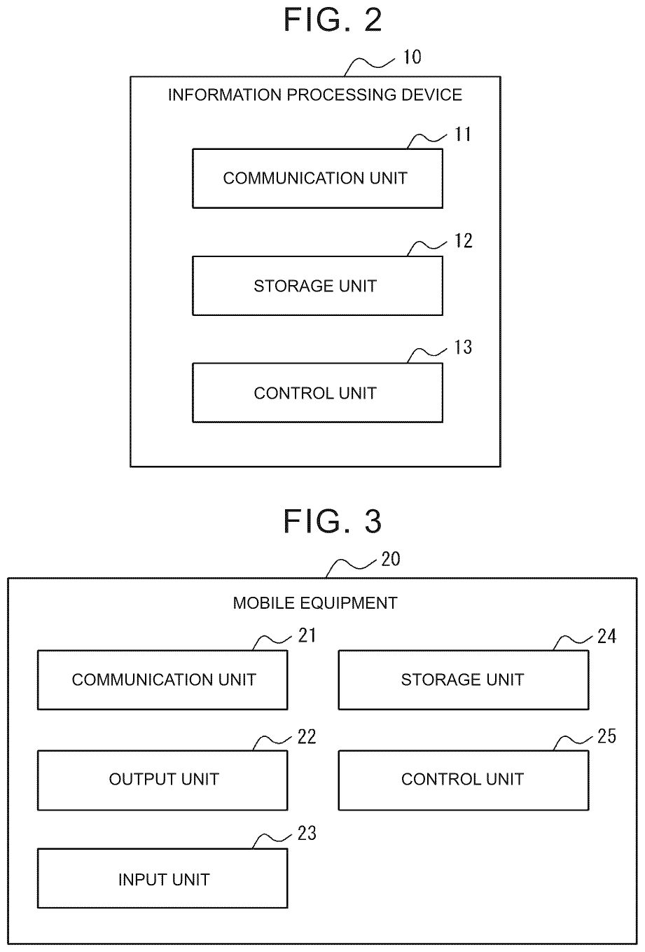

Components included in the information processing device 10 will be described in detail with reference to FIG. 2. The information processing device 10 includes a communication unit 11, a storage unit 12, and a control unit 13.

The communication unit 11 includes one or more communication interfaces connecting to the network 30 such as the Internet. The communication interface supports, for example, a mobile communication standard such as fourth generation (4G) or fifth generation (5G), a wired local area network (LAN) standard, or a wireless LAN standard. However, the supported standard is not limited to these, and the communication interface may support any communication standard.

The storage unit 12 includes one or more memories. The memory may be, but is not limited to, a semiconductor memory, a magnetic memory, or an optical memory. Each memory included in the storage unit 12 may function as, for example, a main storage device, an auxiliary storage device, or a cache memory. The storage unit 12 stores any information to be used for the operation of the information processing device 10. For example, the storage unit 12 may store a system program, an application program, etc.

The control unit 13 includes one or more processors, one or more programmable circuits, one or more dedicated circuits, or a combination thereof. The processor may be, but is not limited to, a general-purpose processor such as a central processing unit (CPU) or a graphics processing unit (GPU), or a dedicated processor specialized for a specific process. The programmable circuit may be, but is not limited to, a field-programmable gate array (FPGA). The dedicated circuit may be, but is not limited to, an application specific integrated circuit (ASIC). The control unit 13 controls the overall operation of the information processing device 10.

### Configuration of Mobile Equipment

Components included in the mobile equipment 20 will be described in detail with reference to FIG. 3. The mobile equipment 20 includes a communication unit 21, an output unit 22, an input unit 23, a storage unit 24, and a control unit 25.

The communication unit 21 includes one or more communication interfaces connecting to the network 30. The communication interface supports, for example, a mobile communication standard. However, the supported standard is not limited to this, and the communication interface may support any communication standard.

The output unit 22 includes one or more output devices that output information to notify the user. The output device may be, but is not limited to, a display that outputs information in the form of a video or a speaker that outputs information in the form of audio. The output unit 22 may include an interface for connecting an external output device.

The input unit 23 includes one or more input devices that detect an input operation performed by the user. The input device may be, but is not limited to, a physical key, a capacitive key, a mouse, a touch panel, a touch screen integrated with the display of the output unit 22, or a microphone. The input unit 23 may include an interface for connecting an external input device.

The storage unit 24 includes one or more memories. Each memory included in the storage unit 24 may function as, for example, a main storage device, an auxiliary storage device, or a cache memory. The storage unit 24 stores any information to be used for the operation of the mobile equipment 20. For example, the storage unit 24 may store a system program, an application program, etc.

The control unit 25 includes one or more processors, one or more programmable circuits, one or more dedicated circuits, or a combination thereof. The control unit 25 controls the overall operation of the mobile equipment 20.

### Operation of Information Processing Device

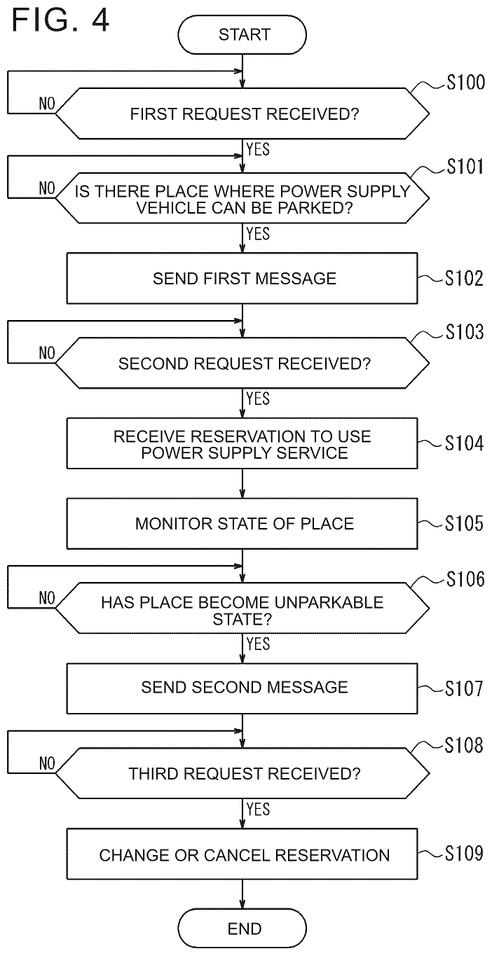

The operation of the information processing device 10 will be described with reference to FIG. 4.

S100: The control unit 13 of the information processing device 10 determines whether a first request has been received from the user's mobile equipment 20. When it is determined that a first request has been received (YES in S100), the process proceeds to S101. When it is determined that a first request has not been received (NO in S100), the process repeats S100.

The “first request” is information indicating a request to check whether there is a place where the power supply vehicle can be parked near the first space where the user's vehicle is parked. The first request is sent from the mobile equipment 20 to the information processing device 10 in response to a first operation performed on the mobile equipment 20 by the user, as will be described later.

S101: When it is determined in S100 that a first request has been received (YES in S100), the control unit 13 determines whether there is a place where the power supply vehicle can be parked near the first space where the user's vehicle is parked. When it is determined that there is such a place (YES in S101), the process proceeds to S102. When it is determined that there is no such place (NO in S101), the process repeats S101.

Any method can be used to determine whether there is a place where the power supply vehicle can be parked. For example, the control unit 13 may receive an image captured by an in-vehicle camera mounted on the user's vehicle and configured to capture an image of the surroundings of the vehicle (that is, the surroundings of the first space) from the user's vehicle via the network 30. Alternatively, the control unit 13 may receive location information indicating the parked location of the user's vehicle from the user's vehicle via the network 30. The control unit 13 may receive an image captured by a surveillance camera installed near the parked location indicated by the location information and configured to capture an image of the surroundings of the first space from the surveillance camera via the network 30. Alternatively, the control unit 13 may receive a satellite image of the surroundings of the first space from an external server via the network 30. The control unit 13 may then determine whether there is a place near the first space where the power supply vehicle can be parked by image recognition using the received image. Specifically, the control unit 13 may determine that there is a place near the first space where the power supply vehicle can be parked, when there is a space near the first space that is large enough for the power supply vehicle to parked and no other vehicle is parked in that space. As used herein, the phrase “near the first space” means, for example, being adjacent to the first space. However, the meaning of this phrase is not limited to this, and it may mean being close enough to the first space for the power supply vehicle to supply power to the user's vehicle parked in the first space.

When it is determined that there is no such place (NO in S101), S101 is repeatedly performed as described above. For example, the control unit 13 may repeatedly perform S101 until a predetermined time elapses, or may repeatedly perform S101 up to a predetermined maximum number of times. When the predetermined time has elapsed or when the control unit 13 has performed S101 the maximum number of times, the control unit 13 may end this operation after sending to the mobile equipment 20 via the communication unit 11 a message indicating that there is no place where the power supply vehicle can be parked.

S102: When it is determined in S101 that there is a place where the power supply vehicle can be parked (YES in S101), the control unit 13 sends to the mobile equipment 20 a first message suggesting to use the power supply service.

The first message sent from the information processing device 10 to the mobile equipment 20 makes the user aware that there is a place near the first space where the power supply vehicle can be parked.

S103: The control unit 13 determines whether a second request has been received from the mobile equipment 20. When it is determined that a second request has been received (YES in S103), the process proceeds to S104. When it is determined that a second request has not been received (NO in S103), the process repeats S103.

The “second request” is information indicating a request for a reservation to use the power supply service. The second request may include any information to be used to process a reservation to use the power supply service. For example, the second request includes location information indicating the parked location of the user's vehicle. However, the second request is not limited to this, and may further include, for example, information such as the amount of power supply desired by the user. The second request is sent from the mobile equipment 20 to the information processing device 10 in response to a second operation performed on the mobile equipment 20 by the user, as will be described later.

When it is determined that a second request has not been received (NO in S103), S103 is repeatedly performed as described above. For example, the control unit 13 may repeatedly perform S103 until a predetermined time elapses, or may repeatedly perform S103 up to a predetermined maximum number of times. The control unit 13 may end this operation when the predetermined time has elapsed or when the control unit 13 has performed S103 the maximum number of times.

S104: When it is determined in S103 that a second request has been received (YES in S103), the control unit 13 receives a reservation to use the power supply service.

Specifically, the control unit 13 receives a reservation to use the power supply service by setting the parked location of the user's vehicle as a destination and determining an operation plan for the power supply vehicle so that the power supply vehicle supplies power to the user's vehicle. When the control unit 13 receives a reservation to use the power supply service, the control unit 13 may predict, for example, the arrival time of the power supply vehicle and the power supply completion time and notify the mobile equipment 20 of the predicted arrival time and power supply completion time. The control unit 13 may notify the power supply vehicle of the determined operation plan via the network 30. A driver of the power supply vehicle or an autonomous driving device of the power supply vehicle may provide the power supply service according to the notified operation plan.

S105: The control unit 13 monitors the state of the place determined to be present in S101, namely the place where the power supply vehicle can be parked.

Any method can be used to monitor the state of the place. For example, the control unit 13 may receive an image captured by an in-vehicle camera mounted on the user's vehicle and configured to capture an image of the surroundings of the vehicle (that is, the surroundings of the first space) from the user's vehicle via the network 30. Alternatively, the control unit 13 may receive an image captured by a surveillance camera installed near the parked location of the user's vehicle and configured to capture an image of the surroundings of the first space from the surveillance camera via the network 30. Alternatively, the control unit 13 may receive a satellite image of the surroundings of the first space from an external server via the network 30. The control unit 13 may continuously receive images and monitor the state of the place where the power supply vehicle can be parked by image recognition using the most recently received image.

Alternatively, in the case where the user's vehicle is parked in a parking lot, the control unit 13 may acquire occupancy information for each parking space in the parking lot from a management server for the parking lot via the network 30. The control unit 13 may continuously receive occupancy information and monitor the state of the place where the power supply vehicle can be parked based on the most recently received occupancy information.

S106: The control unit 13 determines whether the place has become an unparkable state (hereinafter referred to as “specific state”) before the power supply vehicle arrives at the place. When it is determined that the place has become the specific state (YES in S106), the process proceeds to S107. When it is determined that the place has not become the specific state (NO in S106), the process repeats S106.

Specifically, the control unit 13 determines, by, for example, image recognition using the image received in S105, that the place has become the specific state when another vehicle is parked in the place where the power supply vehicle can be parked.

When it is determined that the place has not become the specific state (NO in S106), S106 is repeatedly performed as described above. The control unit 13 may repeatedly perform S106 until the power supply vehicle arrives at the place. The control unit 13 may end this operation when the place continues to be parkable until the power supply vehicle arrives at the place.

S107: When it is determined in S106 that the place has become the specific state (YES in S106), the control unit 13 sends to the mobile equipment 20 a second message suggesting to change or cancel the reservation to use the power supply service.

As will be described later, the second message sent from the information processing device 10 to the mobile equipment 20 allows the user to consider changing or canceling the reservation to use the power supply service after being aware that the place where the power supply vehicle can be parked has become the specific state.

S108: The control unit 13 determines whether a third request has been received from the mobile equipment 20. When it is determined that a third request has been received (YES in S108), the process proceeds to S109. When it is determined that a third request has not been received (NO in S108), the process repeats S108.

The “third request” is information indicating a request to change or cancel the reservation to use the power supply service. The third request is sent from the mobile equipment 20 to the information processing device 10 in response to a third operation performed on the mobile equipment 20 by the user, as will be described later.

When it is determined that a third request has not been received (NO in S108), S108 is repeatedly performed as described above. For example, the control unit 13 may repeatedly perform S108 until a predetermined time elapses, may repeatedly perform S108 up to a predetermined maximum number of times, or may repeatedly perform S108 until the power supply vehicle arrives at the place. The control unit 13 may end this operation when the predetermined time has elapsed, when the control unit 13 has performed S108 the maximum number of times, or when the power supply vehicle has arrived at the place.

S109: When it is determined in S108 that a third request has been received (YES in S108), the control unit 13 changes or cancels the reservation to use the power supply service.

The control unit 13 may send to the mobile equipment 20 via the communication unit 11 a message indicating that the reservation to use the power supply service has been changed or canceled.

### Operation of Mobile Equipment

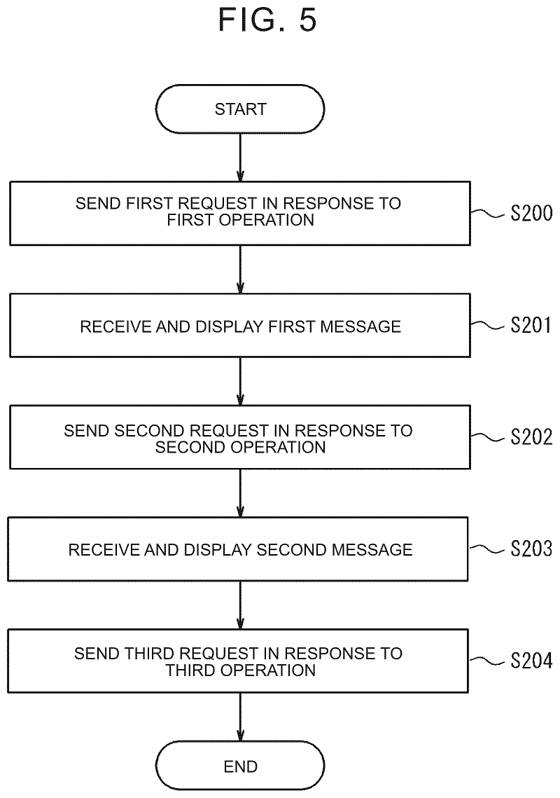

The operation of the mobile equipment 20 will be described with reference to FIG. 5. For example, this operation may be performed during execution of a predetermined application program installed on the mobile equipment 20 or during execution of a web browser.

S200: The control unit 25 of the mobile equipment 20 sends a first request to the information processing device 10 in response to a first operation performed on the mobile equipment 20 by the user.

Typically, the user performs the first operation on the input unit 23 of the mobile equipment 20 when the user thinks of using the power supply service after he or she has moved so far away from the parked vehicle that he or she cannot see it.

S201: When the control unit 25 receives a first message from the information processing device 10, the control unit 25 displays the first message on a display of the output unit 22.

As described above, the first message is a message that is sent from the information processing device 10 when there is a place where the power supply vehicle can be parked near the first space where the user's vehicle is parked, and is a message suggesting to use the power supply service.

S202: The control unit 25 sends a second request to the information processing device 10 in response to a second operation performed on the mobile equipment 20 by the user.

Typically, the user performs the second operation on the input unit 23 of the mobile equipment 20 when he or she thinks of using the power supply service after being aware from the first message that there is a place near the first space where the power supply vehicle can be parked.

S203: When the control unit 25 receives a second message from the information processing device 10, the control unit 25 displays the second message on the display of the output unit 22.

As described above, the second message is a message that is sent from the information processing device 10 when the place has become the unparkable state, namely the specific state, before the power supply vehicle arrives at the place, and is a message suggesting to change or cancel the reservation to use the power supply service.

S204: The control unit 25 sends a third request to the information processing device 10 in response to a third operation performed on the mobile equipment 20 by the user.

Typically, the user performs a third operation on the input unit 23 of the mobile equipment 20 when he or she thinks of changing or canceling the reservation to use the power supply service according to the second message.

As described above, the information processing device 10 according to the present embodiment determines whether there is a place where the power supply vehicle can be parked near the first space where the user's vehicle is parked. When the information processing device 10 determines that there is such a place, it sends to the user's mobile equipment 20 a first message suggesting to use the power supply service.

According to such a configuration, as described above, when there is a place near the user's vehicle where the power supply vehicle can be parked, the first message suggesting to use the power supply service is sent to the user. Even when the user is away from the vehicle, checking the first message makes the user aware that there is a place near the user's vehicle where the power supply vehicle can be parked. Therefore, according to the present embodiment, the technology related to providing a power supply service for dispatching a power supply vehicle is improved in that the probability is reduced that the user may make a reservation to use the power supply service even through there is no place where the power supply vehicle can be parked.

Although the present disclosure is described above based on the drawings and the embodiment, it should be noted that those skilled in the art may make various modifications and alterations thereto based on the present disclosure. It should therefore be understood that such modifications and alterations are within the scope of the present disclosure. For example, the functions included in the configurations, steps, etc. can be rearranged so as not to be logically inconsistent, and a plurality of configurations, steps, etc. may be combined into one or divided into two or more.

For example, in the above embodiment, the configuration and operation of the information processing device 10 may be distributed between or among a plurality of computers that can communicate with each other.

An embodiment is also possible in which, for example, a general-purpose computer functions as the information processing device 10 according to the above embodiment. Specifically, a program describing processing for implementing each function of the information processing device 10 according to the above embodiment is stored in a memory of the general-purpose computer, and the program is read and executed by a processor. Therefore, the present disclosure can also be implemented as a program that is executable by the processor or a non-transitory computer-readable medium that stores the program.

In the above embodiment, when it is determined in S106 that the place where the power supply vehicle can be parked has become the specific state, the control unit 13 of the information processing device 10 sends to the mobile equipment 20 a second message suggesting to change or cancel the reservation to use the power supply service. The control unit 13 may send the second message to the mobile equipment 20 either when the specific state has continued until a predetermined time before the scheduled arrival time of the power supply vehicle, or when the specific state has continued for a predetermined time, whichever occurs first. According to this configuration, the probability is reduced that the second message may be sent even though the place is no longer in the specific state by the time the power supply vehicle arrives at the place.

In the above embodiment, the control unit 13 of the information processing device 10 may send an instruction to project a predetermined image onto the place where the power supply vehicle can be parked, when the control unit 13 receives a reservation to use the power supply service in S104. The destination of the instruction may be determined as desired. For example, in the case where the user's vehicle is equipped with a projector configured to project an image near the vehicle, the control unit 13 may send the instruction to the user's vehicle. For example, in the case where a projector is installed in a parking lot where the user's vehicle is parked, the control unit 13 may send the instruction to a control device of the projector. Projecting an image onto the place where the power supply vehicle can be parked reduces the probability that another vehicle may be parked in the place before the power supply vehicle arrives.

In the above embodiment, the place determined to be present in S101, namely the place where the power supply vehicle can be parked, may include one or more second spaces adjacent to the first space where the user's vehicle is parked. The control unit 13 of the information processing device 10 may send a second message to the mobile equipment 20 in S107 when it is determined in S106 that all the second spaces included in the place have become the specific state.

In the above embodiment, the place determined to be present in S101, namely the place where the power supply vehicle can be parked, may include a pair of third spaces that are adjacent to each other and away from the first space where the user's vehicle is parked. The control unit 13 of the information processing device 10 may send an instruction to move the user's vehicle from the first space to one of the pair of third spaces, when the control unit 13 receives a reservation to use the power supply service in S104. The destination of the instruction may be determined as desired. For example, in the case where the user's vehicle can drive autonomously based on instructions from the outside, the control unit 13 may send the instructions to the user's vehicle or a management server for the vehicle.

Part of the embodiment of the present disclosure is shown by way of example below. However, it should be noted that the embodiment of the present disclosure is not limited to thereto.

### Appendix 1

A method for providing a power supply service for dispatching a power supply vehicle is performed by an information processing device and includes: determining whether there is a place where the power supply vehicle is able to be parked near a first space where a vehicle of a user is parked; and when determination is made that there is the place, sending to mobile equipment of the user a first message suggesting to use the power supply service.

### Appendix 2

In the method according to Appendix 1, the information processing device may determine whether there is the place in response to a first request from the mobile equipment.

### Appendix 3

In the method according to Appendix 1 or 2, the information processing device may determine whether there is the place based on a captured image of surroundings of the first space or occupancy information of a parking lot including the first space.

### Appendix 4

The method according to any one of Appendices 1 to 3 may further include: receiving a reservation to use the power supply service in response to a second request from the mobile equipment, the second request being a request for the reservation to use the power supply service; monitoring a state of the place; and when the place has become a specific state before the power supply vehicle arrives at the place, sending to the mobile equipment a second message suggesting to change or cancel the reservation, the specific state being an unparkable state.

### Appendix 5

In the method according to any one of Appendices 1 to 4, the information processing device may send the second message either when the specific state has continued until a first predetermined time before scheduled arrival time of the power supply vehicle, or when the specific state has continued for a second predetermined time, whichever occurs first.

### Appendix 6

The method according to any one of Appendices 1 to 5 may further include, upon receiving the reservation to use the power supply service, sending an instruction to project a predetermined image onto the place.

### Appendix 7

In the method according to any one of Appendices 1 to 6, the place may include one or more second spaces adjacent to the first space, and the information processing device may send the second message when all the second spaces included in the place have become the specific state.

### Appendix 8

In the method according to any one of Appendices 1 to 7, the place may include a pair of third spaces away from the first space and adjacent to each other, and the method may further include sending an instruction to move the vehicle of the user from the first space to one of the pair of third spaces.

### Appendix 9

A method for reserving a power supply service for dispatching a power supply vehicle is performed by mobile equipment that is used by a user, and includes: sending a first request to an information processing device in response to a first operation performed on the mobile equipment; receiving a first message sent from the information processing device when there is a place where the power supply vehicle is able to be parked near a first space where a vehicle of the user is parked, the first message being a message suggesting to use the power supply service; and sending a second request to the information processing device in response to a second operation performed on the mobile equipment, the second request being a request for a reservation to use the power supply service.

### Appendix 10

A system for reserving a power supply service for dispatching a power supply vehicle includes: an information processing device that is used to provide the power supply service; and mobile equipment that is used by a user. The mobile equipment is configured to send a first request to the information processing device in response to a first operation performed on the mobile equipment. The information processing device is configured to: determine in response to the first request whether there is a place where the power supply vehicle is able to be parked near a first space where a vehicle of the user is parked; and when determination is made that there is the place, send to the mobile equipment a first message suggesting to use the power supply service. The mobile equipment is configured to send a second request to the information processing device in response to a second operation performed on the mobile equipment, the second request being a request for a reservation to use the power supply service. The information processing device is configured to receive the reservation to use the power supply service in response to the second request.

What is claimed is:

1. A method for providing a power supply service for dispatching a power supply vehicle, the method being performed by an information processing device and comprising:
determining whether there is a place where the power supply vehicle is able to be parked near a first space where a vehicle of a user is parked; and
when determination is made that there is the place, sending to mobile equipment of the user a first message suggesting to use the power supply service.

2. The method according to claim 1, wherein whether there is the place is determined in response to a first request from the mobile equipment.

3. The method according to claim 1, wherein whether there is the place is determined based on a captured image of surroundings of the first space or occupancy information of a parking lot where the vehicle is parked.

4. The method according to claim 1, further comprising:
receiving a reservation to use the power supply service in response to a second request from the mobile equipment, the second request being a request for the reservation to use the power supply service;
monitoring a state of the place; and
when the place has become a specific state before the power supply vehicle arrives at the place, sending to the mobile equipment a second message suggesting to change or cancel the reservation, the specific state being an unparkable state.

5. The method according to claim 4, wherein the second message is sent either when the specific state has continued until a first predetermined time before scheduled arrival time of the power supply vehicle, or when the specific state has continued for a second predetermined time, whichever occurs first.

6. The method according to claim 4, further comprising upon receiving the reservation to use the power supply service, sending an instruction to project a predetermined image onto the place.

7. The method according to claim 4, wherein:
the place includes one or more second spaces adjacent to the first space; and
the second message is sent when all the second spaces included in the place have become the specific state.

8. The method according to claim 1, wherein the place includes a pair of third spaces away from the first space and adjacent to each other, the method further comprising sending an instruction to move the vehicle of the user from the first space to one of the pair of third spaces.

9. A method for reserving a power supply service for dispatching a power supply vehicle, the method being performed by mobile equipment of a user and comprising:
sending a first request to an information processing device in response to a first operation performed on the mobile equipment;
receiving a first message sent from the information processing device when there is a place where the power supply vehicle is able to be parked near a first space where a vehicle of the user is parked, the first message being a message suggesting to use the power supply service; and
sending a second request to the information processing device in response to a second operation performed on the mobile equipment, the second request being a request for a reservation to use the power supply service.

10. A system for reserving a power supply service for dispatching a power supply vehicle, the system comprising:
an information processing device configured to provide the power supply service; and
mobile equipment of a user, wherein
the mobile equipment is configured to send a first request to the information processing device in response to a first operation performed on the mobile equipment,
the information processing device is configured to
determine in response to the first request whether there is a place where the power supply vehicle is able to be parked near a first space where a vehicle of the user is parked, and
when determination is made that there is the place, send to the mobile equipment a first message suggesting to use the power supply service,
the mobile equipment is configured to send a second request to the information processing device in response to a second operation performed on the mobile equipment, the second request being a request for a reservation to use the power supply service, and
the information processing device is configured to receive the reservation to use the power supply service in response to the second request.
